(19) United States
(12) Patent Application Publication
(10) Pub. No.: US 2004/0185979 A1
(43) Pub. Date: Sep. 23, 2004

(54) Chain for continuously variable transmission, corresponding continuously variable transmission and motor

(76) Inventors: Peter Schulze, Saint Simeon De Bressieux (FR); Reinhold Friedrich Reber, Richmond Hill (CA)

Correspondence Address: DOWELL & DOWELL PC, SUITE 309, 1215 JEFFERSON DAVIS HIGHWAY, ARLINGTON, VA, 22202

(21) Appl. No.: 10/736,781

(22) Filed: Dec. 17, 2003

(30) Foreign Application Priority Data
Dec. 18, 2002 (FR) 02 16105

(51) Int. Cl. F16H 55/56; F16G 13/02

(52) U.S. Cl. 474/206; 474/8

(57) ABSTRACT

The chain according to the invention comprises a plurality of linking members arranged one behind the other so as to form a closed loop, each linking member comprising two end links intended to come into contact with truncated surfaces of the continuously variable transmission, as well as intermediate links, while pivot pins are provided, allowing the mutual pivoting of two adjacent linking members, which extend through the openings made at least in these intermediate links.

These two pivot pins present a cross-section of substantially triangular shape, which makes it possible to reduce the dimensions of the afore-mentioned openings and consequently to decrease the mass and inertia of the chain.

### FIELD OF THE INVENTION

The present invention relates to a chain for continuously variable transmission, as well as to a continuously variable transmission and a motor equipped with such a chain.

### BACKGROUND OF THE INVENTION

A chain for continuously variable transmission conventionally forms an endless loop wound around two pulleys, of which each is supported by respective input and output shafts. In service, the sides of this chain mesh, by wedging, with two opposite truncated surfaces, belonging to each pulley.

It will be readily appreciated that a modification of the distance separating the two conical surfaces of the same pulley brings about a corresponding modification of the position of the chain. This consequently induces a variation in the transmission ratio.

More precisely, the chain comprises a plurality of linking elements, arranged one behind the other, each of which comprises two lateral end links. Furthermore, different intermediate links are interposed between these end links.

Two adjacent linking elements are mutually articulated, via pins extending transversely to the direction of advance of the chain. Several solutions for making these pins have already been proposed in the prior art.

For example, U.S. Pat. No. 6,346,058 teaches implementing the articulation between two linking elements by means of two pins substantially in the form of half-moons. More precisely, these half-moons are arranged back to back, namely their concavities are directed opposite each other.

However, this first solution presents certain drawbacks, associated in particular with the fact that the contact with the conical surfaces of the pulleys is effected via the ends of the pins. This involves the existence of considerable forces of slide, exerted virtually punctually. This consequently leads to premature wear of the conical surfaces of the pulley, as well as of the chain proper.

A chain for continuously variable transmission is also known from U.S. Pat. No. 4,591,353, in which there is a surface contact between the conical frusta of the pulleys and the lateral links of the chain. To that end, these lateral links are provided with free surfaces presenting a truncated profile conjugate with that of the wedging surfaces, belonging to the pulleys.

Articulation between two adjacent linking elements is effected, in the preceding document, by means of pins of round cross-section.

A chain for continuously variable transmission of similar type is also known, in which this articulation is effected thanks to the presence of two pins in the form of half-moons. This latter solution is described in the Proceedings of the SAE Conference in November 1989, entitled “Development of new drive chains for continuously variable transmissions (CVT)”.

It is an object of the present invention to improve the chains for continuously variable transmission known from the state of the art, in particular by reducing their overall mass.

### SUMMARY OF THE INVENTION

To that end, this invention relates to a chain for continuously variable transmission, comprising a plurality of linking members, arranged one behind the other so as to form a closed loop, each linking member comprising two end links intended to come into contact with truncated surfaces of said continuously variable transmission, as well as intermediate links, while pivot pins are provided, allowing the mutual pivoting of two adjacent linking members, these pivot pins extending through openings for passage made at least in the intermediate links of these two adjacent linking members, characterized in that these two pivot pins present a cross-section of substantially triangular shape.

According to other characteristics of the invention:

the section of the triangular pins presents outer edges which are identical and curved, with a concavity turned towards the inside of this pin.

each opening for passage, made in a corresponding intermediate link, comprises edges for immobilization in which one of the pins is immobilized by cooperation of shapes, the other of these pins being free to rotate in said opening.

the two pins are arranged in abutment against each other by two curved surfaces of which the concavity is turned towards the inside of these pins, so as to define a line of contact which is mobile as a function of the relative orientation of the two adjacent intermediate links.

certain linking members are provided with inwardly offset end links, while other linking members are provided with outwardly offset end links, these different, inwardly and outwardly offset links being in particular arranged alternately, while each inwardly offset end link is provided with orifices for passage of the pins, which are identical to the orifices for passage made in the intermediate links.

the outwardly offset end links present openings for blocking a corresponding pin, each blocking opening presenting identical, curved edges, with a concavity turned towards the inside of this opening.

each edge of the blocking opening or of the pivot pin is substantially in the form of an arc of circle or cardioid.

the edges are connected by curved zones of which the respective centres of curvature form the apices of an equilateral triangle.

the immobilization edges of the opening for passage reproduce the geometry of certain edges of the blocking opening.

a short pin is provided, whose two ends are received in the openings for passage of the inwardly offset end links, as well as a long pin whose two ends are received in the blocking orifices of the outwardly offset end links.

the end links are provided with lateral bosses intended to abut against a corresponding truncated surface of said continuously variable transmission, while the bosses of the inwardly offset end links present a thickness greater than the thickness of the bosses of the outwardly offset end links.

The invention also relates to a continuously variable transmission comprising first and second pulleys, each of which presents opposite truncated surfaces, as well as a chain meshing by wedging with these truncated surfaces, characterized in that this chain is as defined hereinabove.

Finally, the invention relates to a motor, particularly an internal combustion engine, for automobile vehicle, which is equipped with a continuously variable transmission as defined hereinabove.

### BRIEF DESCRIPTION OF THE DRAWINGS

The invention will be more readily understood on reading the following description of a form of embodiment of a chain in accordance with its principle, given solely by way of example and made with reference to the accompanying drawings, in which:

FIG. 1 is a view in perspective, illustrating a continuously variable transmission according to the invention.

FIG. 2 is a view in perspective, illustrating more precisely two adjacent linking elements of the chain of FIG. 1.

FIG. 3 is an exploded view in perspective illustrating the different components of the linking elements of FIG. 2.

FIG. 4 is a front view illustrating an end link belonging to the chain of FIG. 1.

FIG. 5 is a front view of an intermediate link belonging to the chain of FIG. 1.

FIG. 6 is a partial view in perspective of a pin of the chain of the preceding Figures; and

FIG. 7 is a partial schematic representation of the chain of FIG. 1, in the course of use.

### DESCRIPTION OF PREFERRED EMBODIMENT

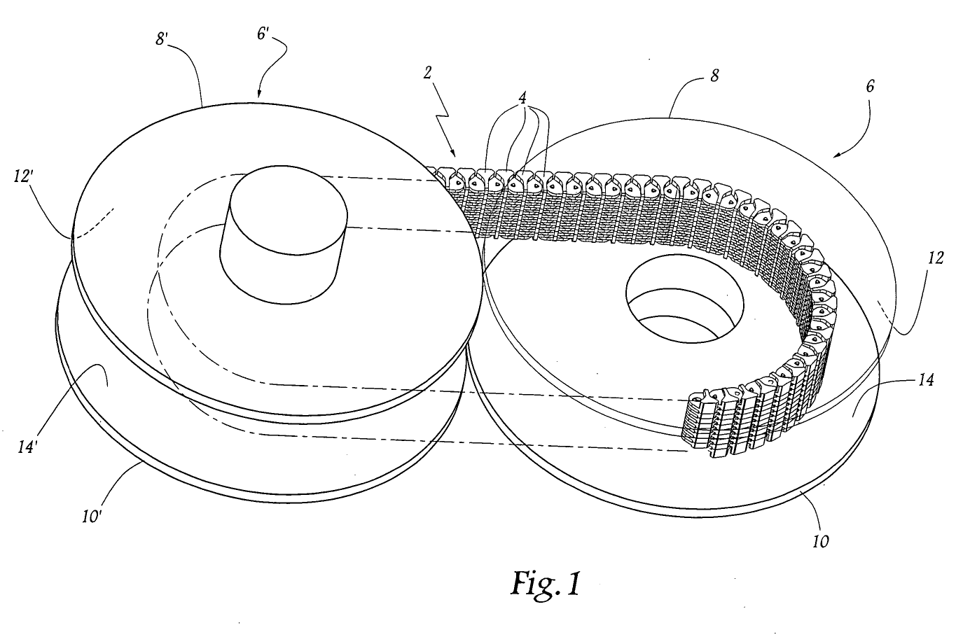

Referring now to the drawings, FIG. 1 illustrates a continuously variable transmission, which firstly comprises a chain 2, formed by a succession of linking members 4, arranged in a closed loop. Two pulleys 6 and 6′ are provided, fast with respectively drive and follower shafts, neither shown in the drawings.

Each pulley 6 or 6′ conventionally comprises two discs 8, 10 and 8′, 10′ respectively, presenting truncated inner surfaces 12, 14 and 12′, 14′ respectively.

In service, the chain 2 meshes, in manner known per se, by wedging with the different discs of the pulleys 6 and 6′. It will be readily appreciated that, when the distance separating two discs of the same pulley is modified, this provokes a variation in the relative position of the chain with respect to this pulley and consequently a modification of the transmission ratio.

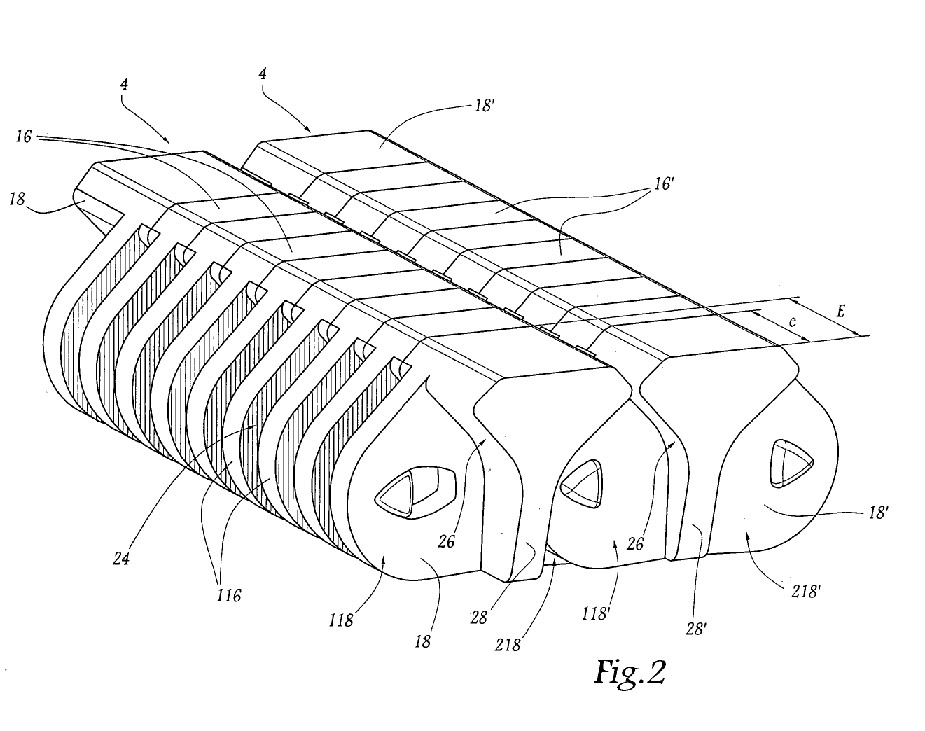

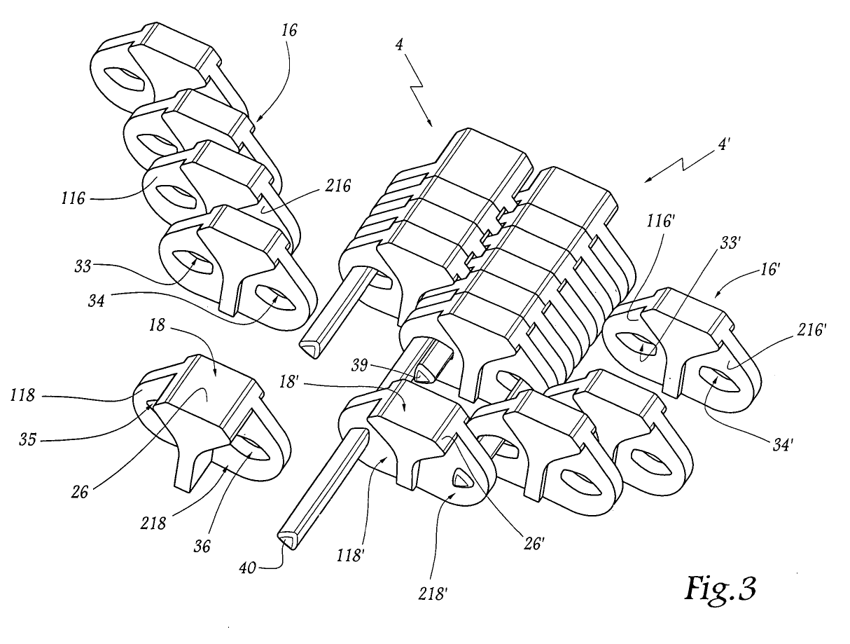

FIGS. 2 and 3 illustrate, in respectively mounted and exploded views, two adjacent linking members 4 and 4′ belonging to the chain 2 shown in FIG. 1.

Each linking member 4 or 4′ comprises a plurality of intermediate links 16 or 16′, which are laterally bordered by two end links 18 or 18′.

Each intermediate link 16 or 16′ is provided with a first axial projection 116 or 116′, as well as with a second axial projection 216 or 216′, extending opposite the first projection. Similarly, each end link 18 or 18′ is provided with two axial projections 118 or 118′, and 218 or 218′ respectively.

Consequently, two adjacent projections, in the present case 116 in FIG. 2, define an intermediary space 24 intended to receive the projection of a link belonging to another linking member, which is not shown here.

Moreover, the end links 18 or 18′ presents, in addition to the afore-mentioned axial projections, a lateral boss 26, 26′ extending opposite the intermediate links.

The free surface 28, 28′ of each boss presents a truncated profile, conjugate with that of the surfaces 12, 12′, 14 and 14′ belonging to the pulleys 6 and 6′. Consequently, in service, these surfaces 28 and 28′ constitute surfaces for wedging the chain 2 by the different discs of the pulleys 6 and 6′.

In addition, it should be noted that the different links of the two linking members 4 and 4′ extend in quincunx. Consequently, within the linking member 4, the number of intermediate links 16 is less, by a value of one, than that of the intermediate links 16′ of the linking member 4′.

This therefore implies that the end link 18 is inwardly offset with respect to the end link 18′. This link 18 therefore presents a boss 26 of which the thickness E is greater than that e of the boss 26′, belonging to the end link 18′ (cf. in particular FIG. 2).

Mutual articulation between the linking members 4 and 4′ is ensured by means of two pins 39 and 40, penetrating through orifices made in different projections of the links, as will be explained hereinafter.

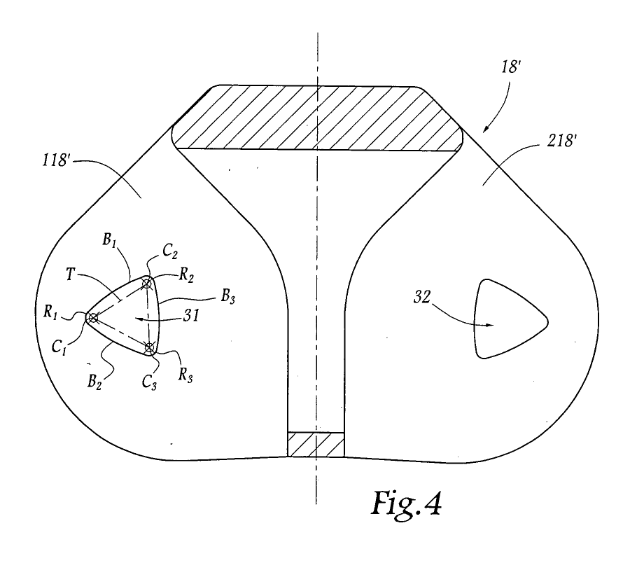

FIG. 4 firstly illustrates an end link 18′ located laterally outermost of the chain. Each projection 118′ and 218′ of this link 18′ has a corresponding opening 31 and 32 made therein.

The opening 31 is thus defined by three edges B₁, B₂, B₃ which are curved and with concavity turned towards the inside of this orifice. The edges B₁ and B₂ are connected by a zone of connection R₁ of which C₁ denotes the centre of curvature.

Similarly, the zones of connection R₂ and R₃, of which C₂ and C₃ denote the centres of curvature, are respectively defined between the edges B₁ and B₃ and between edges B₂ and B₃. These edges B₁, B₂, B₃ are identical, in that they present the same length and the same radius of curvature.

It should be noted that this radius of curvature is relatively great, with the result that the opening 31 may be considered as substantially triangular. In this respect, the centres of curvature C₁, C₂ and C₃ form the apices of an imaginary equilateral triangle T, which is shown in dashed and dotted lines in this FIG. 4.

It should also be noted that the rounded profile of the zones of connection R₁, R₂ and R₃ avoids creating incipient crack zones between the edges B₁, B₂ and B₃.

The opening 32, substantially similar to opening 31, is arranged approximately symmetrically with respect to a median axis of the link, extending vertically in the present case.

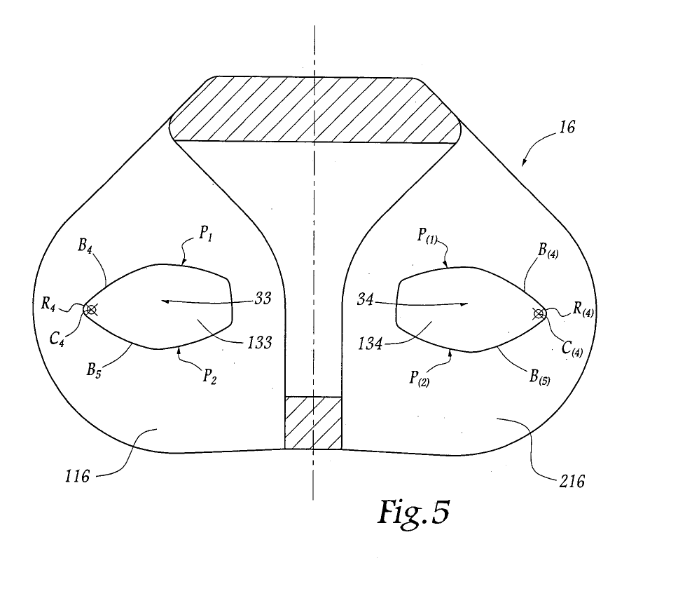

FIG. 5 illustrates the openings made in the different projections 116, 116′, 216 and 216′ of the intermediate links 16 and 16′.

The opening 33 of one of these links, here the one given reference 16, is bordered by two peripheries P₁ and P₂ joined, to the left in this FIG. 5, by a zone of connection R₄ of which C₄ denotes the centre of curvature. In their parts close to zone R₄, the peripheries P₁ and P₂ define edges B₄ and B₅ presenting a profile identical to that of peripheral edges B₁ and B₂ of openings 31 and 32 in FIG. 4. The edges B₄ and B₅ may thus be superposed with those B₁ and B₂.

On the other hand, it should be noted that this opening 33 presents dimensions substantially greater than those of opening 31. In effect, the latter is truncated via the edge B₃, while the opening 33 extends in a terminal portion, denoted 133, in which one of the pins may pivot, as will be seen hereinafter.

Furthermore, the other opening 34, made in the projection 216 of the intermediate link 16, presents a shape similar to that of opening 33, being approximately symmetrical with respect to the median vertical axis. The elements of this opening 34 are thus designated by the same references as those of opening 33, to which parentheses are added, namely P₍₁₎, P₍₂₎, B₍₄₎, B₍₅₎, C₍₄₎ and R₍₄₎.

This opening 34 may be superposed, in its right-hand part in the drawing, with the opening 32 of FIG. 4, while extending in a terminal portion 134 located to the left in the drawing.

As illustrated in particular in FIG. 3, the links 16′ of the other linking member 4′ present openings 33′ and 34′ similar to those 33 and 34 hereinabove. Finally, the inwardly offset end links 18 present openings 35 and 36 similar to those 33 and 34.

With a view to mutual articulation of the two members 4 and 4′, two pins are also provided, arranged side by side, intended to penetrate in the different openings of the links.

More precisely, one of these pins, 39, is called short, insofar as its two ends are received in one of the openings 35 or 36 of the outer, inwardly offset link 18. On the other hand, the other of these pins, 40, is called long, insofar as its ends are received in one of the orifices 31 or 32 of the outwardly offset end link 18′.

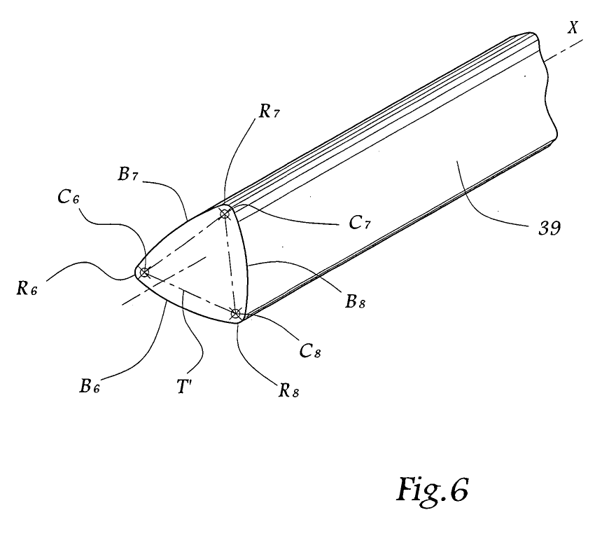

FIG. 6 illustrates the profile of the short pin 39 more precisely.

This pin 39 is cylindrical, with substantially triangular base, its cross-section being unvarying over the whole of its length. This cross-section is identical to that of the orifice 31 or 32, in that the pin 39 presents curved edges B₆, B₇ and B₈ having the same dimensions as the edges B₁ to B₃.

The concavity of these edges B₆ to B₈ is turned towards the central geometrical axis X, these edges being joined by zones of connection respectively denoted R₆, R₇, R₈, of which the centres of curvature C₆, C₇, C₈ define the apices of an imaginary equilateral triangle T′, having the same dimensions as triangle T of FIG. 4.

It should be noted that the elements of the long pin 40, which presents a profile identical to that of the short pin 39, are designated by the same references to which a “prime” has been added, namely B′₆ to B′₈, R′₆ to R′₈ as well as C′₆ to C′₈.

It follows from the foregoing that two of the edges B₆ to B₈ or B′₆ to B′₈ of the pins 39 or 40 may come into contact with the edges, particularly those referenced B₄ and B₅, of the large-dimensioned openings 33 to 36. Furthermore, in the case of the long pin 40, the latter may be inserted in one of the openings 31 or 32, its edges B′₆ to B′₈ in that case coming into contact with edges B₁ to B₃ respectively.

In this regard, it is unnecessary to chose a particular orientation of the pins 39 or 40 with respect to the different orifices, this facilitating assembly of the chain.

The shape of the different edges set forth hereinabove is chosen in order to optimalize the transmission of the efforts between the pins 39 and 40. It was determined by calculation that the most suitable theoretical shape is that of a cardioid, such a shape being reasonably approximated by an arc of circle.

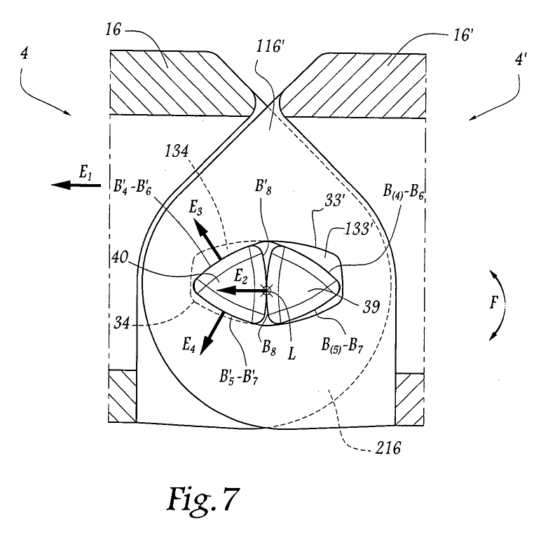

FIG. 7 shows a partial view, on a larger scale, illustrating the two members 4 and 4′ when the chain 2 is under normal operating conditions.

This Figure partially shows the projection 216 of an intermediate link 16 of the first member 4, as well as the projection 116′ of an intermediate link 16′ of the other member 4′. The opening 33′ made in the projection 116′ and the opening 34 made in the projection 216 are therefore visible.

The short pin 39 comes into contact, by its edges B₆ and B₇, with the edges B₍₄₎ and B₍₅₎ of the opening 34. Furthermore, the long pin 40 comes into contact, by its edges B′₆ and B′₇, with the edges B′₄ and B′₅ of the opening 33′.

Finally, the two ends of the short pin 39 (not shown in this Figure) are received in the openings 36 of the two end links 18, belonging to the linking member 4. The long axis 40 (likewise not shown) is immobilized at its two ends, by cooperation of shapes, inside the orifices 31 of the outwardly offset end link 18′.

The transmission of an effort of traction E₁ exerted on the links 16 and 16′ is effected by abutment of the short pin 39 on the long pin 40, at the level of their respective ends B₈ and B′₈. This generates an effort E₂ at the level of a line of contact L between these opposite edges.

Due to the geometry of these pins and the different orifices, in particular opening 31, this effort of traction is distributed at the level of the edges B′₄ and B′₅ of the orifice 33 into two elementary efforts E₃ and E₄ of lesser intensity.

Moreover, when the two links 16 and 16′ pivot mutually (arrow F), each pin is wedged in one of the openings while being free to pivot with respect to the other. More precisely, the pin 39 is fast in rotation with the walls of the opening 34, but may pivot inside the part 133′ of the opening 33′, while the pin 40 is fast in rotation with the walls of the opening 33′ while being able to pivot inside the part 134 of the opening 34.

The invention makes it possible to attain the objects set forth hereinabove.

Thus, by employing two substantially triangular pins, penetrating in the openings of the different links, the dimension of these openings can be reduced compared to the different solutions envisaged in the prior art. Consequently, this ensures a decrease in the total height of this chain, with corresponding reduction of its mass.

Consequently, the invention guarantees a decrease in the overall inertia of the chain.

In addition, the chain of the invention presents a slight elongation and proves to be particularly satisfactory from the acoustic standpoint.

Furthermore, it should be noted that the use of triangular pins is, surprizingly, not detrimental to the mechanical integrity of the chain for continuously variable transmission.

Although these triangular pins present reduced dimensions, they prove capable of withstanding the different efforts to which this transmission chain is subjected. It is thus question of a first effort, parallel to the advance of the chain, as well as of a supplementary effort, perpendicular to this direction of advance, which is due to the action of wedging of the chain between the truncated surfaces of the pulley discs.

The efforts evoked hereinabove are of nature and orientation distinct from those to which is subjected a distribution chain which is not intended for use in continuously variable transmission. They therefore constitute a specificity of this latter type of transmission.

Finally, the reliability of the chain of the invention proves to be satisfactory, giving it a duration of use greater than 500 000 kms.

What is claimed is:

1. Chain for continuously variable transmission, comprising a plurality of linking members, arranged one behind the other so as to form a closed loop, each linking member comprising two end links intended to come into contact with truncated surfaces of said continuously variable transmission, as well as intermediate links, while pivot pins are provided, allowing the mutual pivoting of two adjacent linking members, these pivot pins extending through openings for passage made at least in the intermediate links of these two adjacent linking members,
wherein these two pivot pins present a cross-section of substantially triangular shape.

2. The chain of claim 1, wherein the cross-section of the triangular pins presents outer edges which are identical and curved, with a concavity turned towards the interior of this pin.

3. The chain of claim 1, wherein each opening for passage made in a corresponding intermediate link comprises immobilization edges in which one of the pins is immobilized by cooperation of shapes, the other of these pins being free to rotate in said opening for passage.

4. The chain of claim 3, wherein the two pins are arranged in abutment against each other by two curved surfaces of which the concavity is turned towards the interior of these pins, so as to define a line of contact which is mobile as a function of the relative orientation of the two adjacent intermediate links.

5. The chain of claim 1, wherein certain linking members are provided with inwardly offset end links, while other linking members are provided with outwardly offset end links, these different, inwardly and outwardly offset links being in particular arranged alternately, and each inwardly offset end link is provided with orifices for passage of said pins, which are identical to the orifices for passage made in the intermediate links.

6. The chain of claim 5, wherein the outwardly offset end links present openings for blocking a corresponding pin, each blocking opening presenting identical, curved edges, with a concavity turned towards the inside of this opening.

7. The chain of claim 2, wherein each edge of the blocking opening or of the pivot pin is substantially in the form of an arc of circle or cardioid.

8. The chain of claim 7, wherein said edges are connected by curved zones of which the respective centres of curvature form the apices of an equilateral triangle.

9. The chain of claim 6, wherein the immobilization edges of the opening for passage reproduce the geometry of certain edges of the blocking opening.

10. The chain of claim 6, wherein a short pin is provided, whose two ends are received in the openings for passage of the inwardly offset end links, as well as a long pin whose two ends are received in the blocking orifices of the outwardly offset end links.

11. The chain of claim 5, wherein the end links are provided with lateral bosses intended to abut against a corresponding truncated surface of said continuously variable transmission, and the bosses of the inwardly offset end links present a thickness greater than the thickness of the bosses of the outwardly offset end links.

12. Continuously variable transmission comprising first and second pulleys, each of which presents opposite truncated surfaces, as well as a chain meshing by wedging with these truncated surfaces, wherein this chain is in accordance with claim 1.

13. Motor, particularly an internal combustion engine, for automobile vehicle equipped with a continuously variable transmission according to claim 12.
